(19) United States
(12) Patent Application Publication
(10) Pub. No.: US 2006/0149751 A1
(43) Pub. Date: Jul. 6, 2006

(54) Custom templates

(76) Inventors: Sripad Jade, Srinivas Nagar (IN); Uma Kant Singh, Kundalahalli (IN); Harish Porwal, Jayanagar (IN)

Correspondence Address: KENYON & KENYON LLP, 1500 K STREET N.W., SUITE 700, WASHINGTON, DC, 20005, US

(21) Appl. No.: 11/024,941

(22) Filed: Dec. 30, 2004

(51) Int. Cl. G06F 17/00

(52) U.S. Cl. 707/100

(57) ABSTRACT

The present invention is directed to the use of custom templates to generate user interface screens in computer systems. In embodiments of the present invention, a data structure for supporting user interfaces may include a base template created by a developer for particular display devices and a delta file defining changes to the base templates manifested when the user interface screen is generated. Exemplary applications include small display devices having display, memory, and processing power limitations

### FIELD OF INVENTION

This invention is in the area of computer user interface screens and, more particularly, user interface screen generation from custom templates.

### BACKGROUND OF THE INVENTION

Developers generally create computer user interface screens from either pre-defined templates, known as “patterns,” or from freestyle development (from scratch). Generally, pre-defined templates are created and supplied by an application software vendor. When using these pre-defined templates, a developer typically selects a template, pre-defined to perform a particular function, that the developer wants to use as a user interface screen. The benefit of pre-defined templates is that they provide screen consistency across applications. Also, the developer is able to design user interface screens quickly and easily. But the disadvantage is that the developer has little flexibility in tailoring the user interface screen to the application and/or display device that uses the user interface screen. This limitation is particularly troublesome for small display devices that have display size, memory, and processing power constraints. That is, the pre-defined templates may be spatially oversized or have configurations that are too complex for the small display device's memory and/or processing power. Further, for the small display devices, screen sizes differ among different products, which makes it difficult to design a small set of templates having broad application.

In contrast, freestyle development provides maximum flexibility to the developer to create user interface screens specifically tailored for the display device. When creating user interface screens from scratch, the developer typically designs all the controls, layout, attributes, colors, fonts, etc., for the user interface screens. This avoids the problem of pre-defined templates in small display devices. However, the disadvantage is that freestyle development is much slower and more labor-intensive for the developer. Also, screen consistency between applications is lost. Since the freestyle-developed screens are designed for particular devices and/or applications, they are typically not reusable between devices and applications.

During runtime, pre-defined templates have additional advantages. They generally display quickly because the parameters used to generate a display based on the templates are static and pre-defined. As such, the application need only retrieve and apply the parameters' values to generate the user interface screen.

In contrast, for freestyle development, the user interface screens created from scratch are typically not saved as templates. As such, during runtime, the application must create the user interface screen controls, as designed by the developer, and initialize the controls as the user interface screen is displayed. Hence, screens built from scratch generally display slowly. This means that the application must perform complex calculations, make numerous memory searches, etc., to display screens created from scratch.

There is a need in the art for computer user interface screen development that combines the benefits of pre-defined templates and freestyle development without their respective disadvantages.

### BRIEF DESCRIPTION OF DRAWINGS

FIG. 1 illustrates systems for which custom templates may be used according to embodiments of the present invention.

FIG. 2 is a block diagram of an example architecture for displaying user interface screens according to an embodiment of the present invention.

FIG. 3 is a flowchart of a runtime method for displaying user interface screens according to an embodiment of the present invention.

FIG. 4 is a block diagram of an example architecture for creating custom templates upon which user interface screens are based, according to an embodiment of the present invention.

FIG. 5 is a flowchart of a design method for creating custom templates upon which user interface screens are based, according to an embodiment of the present invention.

### DETAILED DESCRIPTION

This invention is drawn to custom templates. Custom templates may be created from base templates that are customized with delta files for a particular display device and/or application. Base templates may be definitions of elements of computer user interface screens, e.g., screen controls, fonts, colors, layout, etc., used by applications to generate user interface screens. The base templates may be created for either a generic or specific display device and/or application. Delta files may include customized modifications to the definitions in the base templates. The delta files and the base templates together may form custom templates. These custom templates then may be used at runtime to generate user interface screens.

Custom templates may be particularly suited for use in small display devices, such as personal digital assistants (PDAs), tablet computers, laptops, smart phones, and portable terminals. Compared to desktop computers, these small display devices are more limited in screen size, memory capacity, and processing power. Therefore, pre-defined templates used in screen development for desktop computers generally are not portable to small display devices. Custom templates allow the developer to design templates to meet the requirements of these small display devices, store these templates, and then reuse them in screen development. As such, the developer need not create user interface screens from scratch every time. Instead, the developer may use a custom template that is created from a base template and modified to further customize, as needed, for a particular device and/or application.

In embodiments of the present invention, developers may create base templates from scratch, as in freestyle development, and then use them multiple times with different delta files to create custom templates that are then used to generate user interface screens, just as pre-defined templates do. Hence, custom templates provide the advantages of both pre-defined templates and freestyle development without their respective disadvantages.

Alternatively, developers may select an existing base template, add definitions to the template, and then save as a new base template.

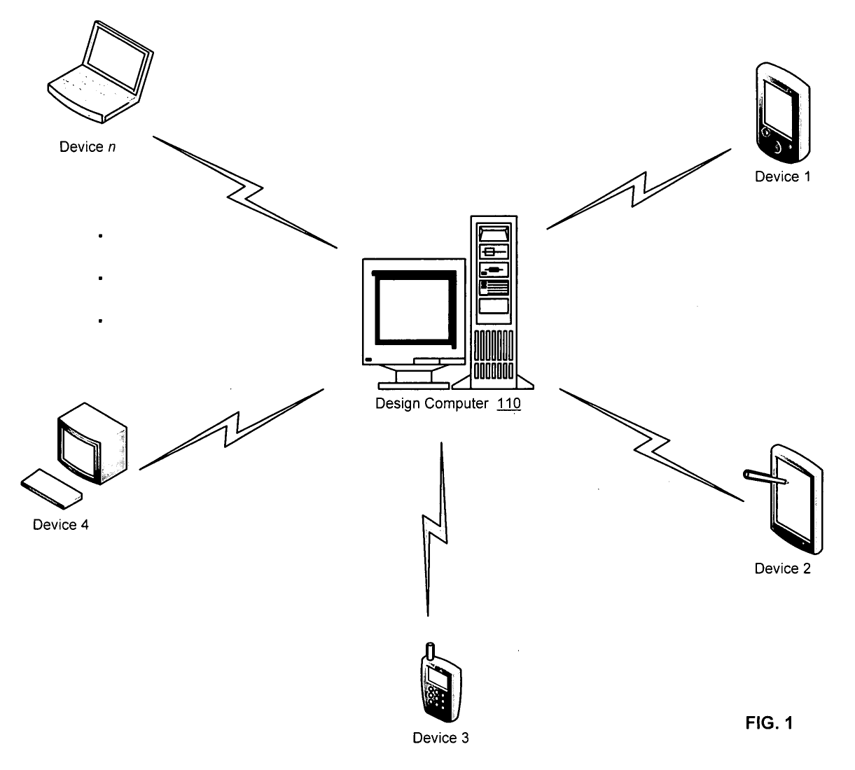

FIG. 1 illustrates systems for which custom templates may be used according to embodiments of the present invention. In this system, a developer may use a design tool on design computer 110 to design and store base templates and to design and separately store delta files for the base templates. The developer may then link the delta files to their respective underlying base templates. After completing the base templates and delta files, the developer may transmit them to the appropriate small display devices 1, 2, . . . , n. The small display devices may then use them during runtime to generate user interface screens.

The design computer may be any type of computer capable of performing the design tool operations according to embodiments of the present invention. The transmission media may be any type capable of sending and receiving data between the design tool and the small display devices according to embodiments of the present invention.

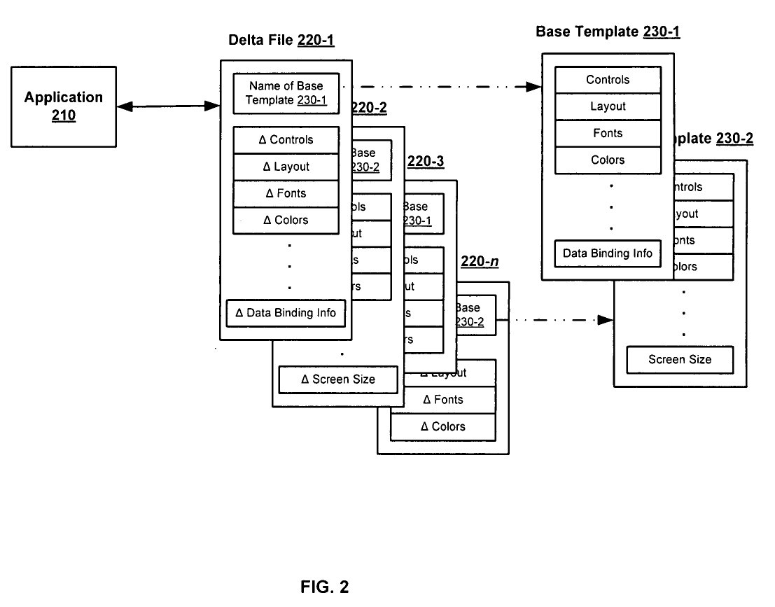

FIG. 2 is a block diagram of an example architecture for displaying user interface screens according to an embodiment of the present invention. This architecture, which may be resident in the small display device that is to display user interface screens, may include application 210, delta files 220-1, . . . , 220-n, and base templates 230-1, 230-2. Base templates 230 may be created using the design tool. A base template may include definitions of elements of a user interface screen for the device and element default values. Examples of screen elements include the controls to be used, the screen layout, the screen properties, e.g., fonts, colors, etc., and the data binding information.

Controls are objects on the screen that can be manipulated by the user to enter commands to the device. Typical controls include buttons, scroll bars, pull-down menus, etc. Data binding information provides the bounds of the controls, such as the routines that are called to perform the user-selected actions when the user manipulates the controls, the type of editor through which the user manipulates the controls, e.g., a text editor, an input field, a radio button, etc., and the data type of the controls' values, e.g., text, value, selectKey, etc.

It is to be understood that screen elements are not limited to those described here, but may include any elements capable of being used in user interface screens.

Delta files 220 of FIG. 2 may also be created using the design tool. A delta file may include modifications to base templates 230 for the particular device and/or application. A delta file 220 may include modifications to the definitions and values of the elements defined in an underlying base template 230. The delta file may also include a pointer to the base template. Optionally, the delta file may include additional elements not defined in the base template. These additional elements may be treated as freestyle development during runtime, such that the application may retrieve the template-defined elements and then create and initialize the additional elements.

Several delta files 220 may have pointers to the same base template 230. For example, in FIG. 2, delta files 220-1 and 220-3 have pointers to base template 230-1. As such, a custom template may be created from delta file 220-1 making changes to base template 230-1. A different custom template may created from delta file 220-3 making different changes to base template 230-1.

To display a user interface screen based on the delta file and base template, the application may retrieve the delta file, which points to the base template, and then retrieve the base template.

This architecture advantageously conserves memory on the small display device by providing multiple delta files for a common base template that generate multiple user interface screens.

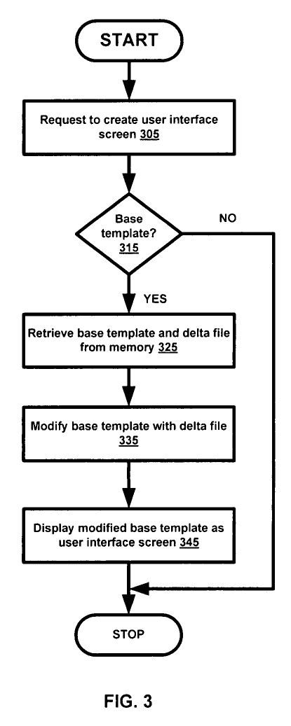

FIG. 3 is a flowchart of a runtime method for displaying user interface screens according to an embodiment of the present invention. During application runtime, the application may request the creation of a user interface screen (305). The application may determine whether the screen is to be created from a base template (310). If so, the application may perform as follows.

The application may retrieve the desired user interface screen's delta file from memory and read the delta file pointer to determine the underlying base template. The application may then retrieve the base template (325). The application may modify the elements of the base template with the delta file (335). The application may then display the modified base template, i.e., the custom template, as a user interface screen (345). The application may place the retrieved base template into cache memory for later quick retrieval.

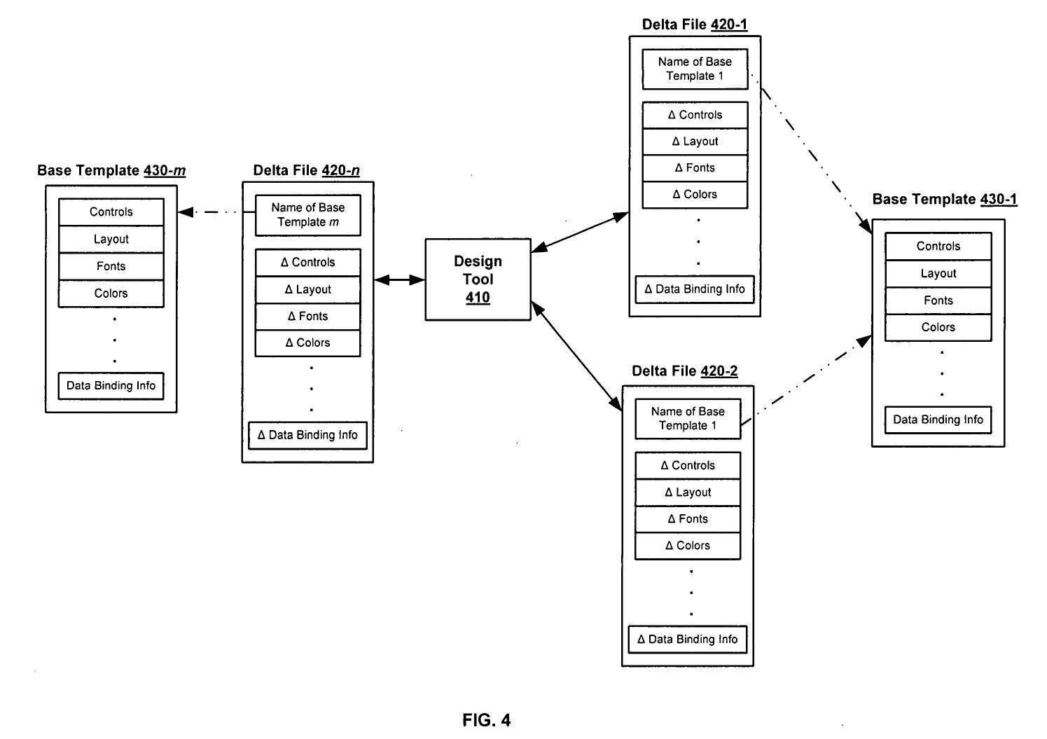

FIG. 4 is a block diagram of an example architecture for creating custom templates upon which user interface screens are based, according to an embodiment of the present invention. This architecture, which may be resident in design computer 110 that creates the base templates and delta files, may include design tool 410, delta files 420-1, . . . , 420-n, and base templates 430-1, . . . , 430-m. Design tool 410 may create the base templates from scratch and then store them in memory. Alternatively, design tool 410 may create new base templates from existing base templates. Design tool 410 may also create delta files 420 based on a base template 430, create a pointer to the underlying base template 430, and store the delta file 420 in memory. One or more delta files 420 may point to the same base template 430.

Upon completion of a delta file and base template, the design application may transmit them to the appropriate small display devices to be used there to generate user interface screens.

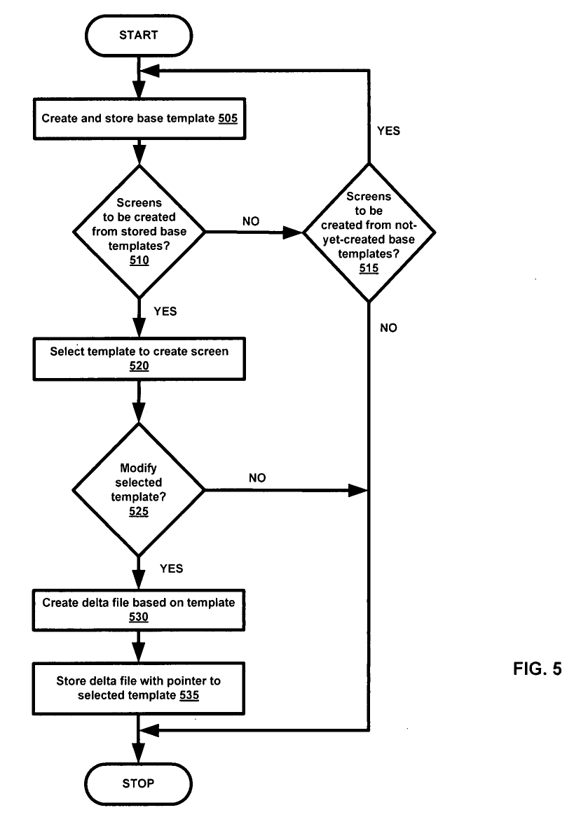

FIG. 5 is a flowchart of a design method for creating custom templates upon which user interface screens are based, according to an embodiment of the present invention.

The design tool may receive the developer's inputs to create and store a base template in memory (505). The inputs may include all the controls to be used, the screen layout, the screen properties such as font, colors, etc, and the data binding information. The base template may be stored under a name supplied by the developer so that the template can be readily identified for use.

The design tool may then receive an input from the developer about whether the developer wants to use the stored base template to create user interface screens (510). If not, the design tool may then receive an input from the developer about whether the developer wants to create and store another base template (515). If so, the design tool repeats the create and store operation (505). Otherwise, the design tool exits.

To create user interface screens from a stored base template, the design tool may display a list or table of the stored templates from which the developer may select (520). After receiving the developer's template selection, the design tool may then receive an input from the developer about whether the developer wants the user interface screen to be a modified version of the selected base template (525). If not, the design tool may exit.

If the developer wants the user interface screen to be a modified version of the base template, the design tool may receive the developer's inputs that include changes to the elements and values defined in the base template and store the changes in a delta file (530). Optionally, the developer's inputs may include definitions of new elements not in the base template to be stored in the delta file. The design tool may then create a pointer from the delta file to the base template and store the delta file in memory (535).

This method may be repeated for as many times as needed to use custom templates comprising base templates and delta files for user interface screens.

Embodiments of the present invention may be implemented using any type of computer, such as a general-purpose microprocessor, programmed according to the teachings of the embodiments. The embodiments of the present invention thus also includes a machine readable medium, which may include instructions used to program a processor to perform a method according to the embodiments of the present invention. This medium may include, but is not limited to, any type of disk including floppy disk, optical disk, and CD-ROMs.

It may be understood that the structure of the software used to implement the embodiments of the invention may take any desired form, such as a single or multiple programs. It may be further understood that the method of an embodiment of the present invention may be implemented by software, hardware, or a combination thereof.

The above is a detailed discussion of the preferred embodiments of the invention. The full scope of the invention to which applicants are entitled is defined by the claims hereinafter. It is intended that the scope of the claims may cover other embodiments than those described above and their equivalents.

1. A data structure for support of user interfaces in a computer system, comprising:
a base template defining parameters of a plurality of user interface elements; and
a delta file defining changes to the parameters, wherein the base template and the delta file are represented in a user interface screen.

2. The data structure of claim 1, wherein the delta file includes a pointer to the base template.

3. The data structure of claim 1, wherein the parameters include at least one of controls, screen layout, fonts, and colors.

4. The data structure of claim 1, wherein the delta file also defines new parameters not defined in the base template.

5. The data structure of claim 1, further comprising a second delta file defining different changes to the parameters and including a pointer to the base template, wherein the base template and the second delta file are represented in another user interface screen.

6. A computer system comprising memory to store data of a user interface, the memory including storage for at least one base template defining parameters of a plurality of user interface elements and at least one delta file defining changes to the parameters to be made in a user interface screen based on the base template.

7. The computer system of claim 6, wherein the memory further includes storage of an application for displaying the user interface screen.

8. The computer system of claim 7, further comprising a processor configured to execute the application, wherein the processor causes the application to retrieve the delta file from memory, read a pointer in the delta file to the base template, and retrieve the base template.

9. The computer system of claim 8, wherein the processor further causes the application to display the base template and the delta file as the user interface screen.

10. The computer system of claim 6, further comprising a design tool, in communication with the memory, configured to create the base template and the delta file and to transmit the base template and the delta file to storage.

11. A method of generating a user interface screen, comprising:
retrieving from memory a base template defining parameters of a plurality of user interface elements and a delta file defining changes to the parameters to be made in the user interface screen based on the base template;
changing the parameters of the base template in the delta file; and
generating the user interface screen according to the changed parameters.

12. The method of claim 11, further comprising receiving a request from an application to generate the user interface screen.

13. The method of claim 11, wherein the retrieving comprises:
retrieving the delta file from memory;
reading a pointer in the delta file to the base template; and
retrieving the pointed-to base template.

14. The method of claim 11, wherein the changing comprises:
defining in the delta file different values for the parameters than those in the base template.

15. The method of claim 11, wherein the generating comprises:
generating the user interface screen from the base template;
modifying the user interface screen according to the delta file; and
displaying the modified user interface screen on a display device.

16. A method of creating a template upon which a user interface screen is based, comprising:
defining parameters of a plurality of user interface elements;
storing the parameters as a template;
creating a file defining changes to the parameters;
defining a pointer from the file to the template; and
storing the file with the pointer.

17. The method of claim 16, wherein the defining parameters comprises:
defining at least one of controls, screen layout, fonts, and colors for the user interface screen.

18. The method of claim 16, wherein the creating comprises:
defining changes in at least one of controls, screen layout, fonts, and colors defined in the template.

19. The method of claim 16, further comprising:
creating a second file defining different changes to the parameters;
defining a second pointer from the second file to the template; and
storing the second file with the second pointer.

20. The method of claim 16, further comprising:
selecting one of a plurality of templates upon which to base the user interface screen; and
creating the file defining the changes to the selected one of the templates.
